(19) United States
(12) Patent Application Publication
(10) Pub. No.: US 2006/0267351 A1
(43) Pub. Date: Nov. 30, 2006

(54) Latch for a vehicle

(76) Inventor: Nigel Spurr, Solihull (GB)

Correspondence Address: CARLSON, GASKEY & OLDS, P.C., 400 WEST MAPLE ROAD, SUITE 350, BIRMINGHAM, MI, 48009, US

(21) Appl. No.: 11/417,517

(22) Filed: May 4, 2006

(30) Foreign Application Priority Data
May 7, 2005 (GB) 0509350.5

(51) Int. Cl. E05C 3/06

(52) U.S. Cl. 292/216

(57) ABSTRACT

A latch assembly includes a latch bolt having a power closure abutment, a first safety abutment and a closed abutment that is moveable between an open position, a first safety position and a closed position. The latch assembly includes a pawl including a pawl tooth having an engaged position defined by engagement between the pawl tooth and one of the first safety abutment and the closed abutment at which the pawl releaseably retains the latch bolt in one of the first safety position and the closed position, respectively, and a released position in which the latch bolt is free to move to the open position. The latch assembly also includes a closure element having a first abutment and a second abutment. The first abutment is releaseably engageable with the closure abutment. The closure element has a first position at which the closure element is disengaged from the closure abutment, a second position at which the first abutment of the closure element is engaged with the closure abutment and the latch bolt is in the first safety position, and a third position at which the first abutment of the closure element is engaged with the closure abutment and the latch bolt is in the closed position. When the closure element is in the first position and the latch bolt is in the first safety position, actuation of a power actuator causes the closure element to move through the second position to the third position, thereby closing the latch. During movement of the closure elements from the second position into the third position, the closure abutment is positioned generally between the first abutment and the second abutment.

### REFERENCE TO RELATED APPLICATION

This application claims priority to United Kingdom Application GB 0509350.5 filed on May 7, 2005.

### BACKGROUND OF THE INVENTION

The present invention relates generally to a latch, in particular a latch for a passenger door or driver door of a land vehicle, such as an automobile.

Latches which enable vehicle doors are known, in particular car doors that are to be held in a closed position. Such known latches also allow the door to be held in a first safety position, i.e., a position at which the door will not open, but which nevertheless is not a fully closed position.

Some vehicle door latches incorporate a power closure system wherein the door is manually closed to the first safety position. A power actuator, typically an electric motor, closes the door from the first safety position to the fully closed position. Such a latch is shown in U.S. Pat. No. 4,892,339. In this case, a rotating claw is engaged at a peripheral edge by a pawl which holds the claw in the first safety position. A motor then moves the entire pawl, which in turn rotates the claw to the fully closed position.

The claw and the pawl are safety critical components. If the pawl becomes disengaged from the claw during an accident, the door can open, thereby possibly endangering the occupants of the vehicle. Thus, those components associated with moving the pawl of U.S. Pat. No. 4,892,339 become safety critical components and must be able to withstand impact loads. Therefore, they are necessarily expensive and/or heavy.

Other known power closure latches separate the latching function from the power closure function. Such arrangements are shown in U.S. Pat. No. 5,273,324, U.S. Pat. No. 5,564,761 and U.S. Pat. No. 5,288,115. The power closure components of these latches are not safety critical during a road crash, and therefore they can be made lighter, less strong and from cheaper materials. In U.S. Pat. No. 5,273,324, a power closure link is in permanent engagement with the rotating claw and with a rotatable lug which can be moved via a lever attached to a bowden cable. This system incorporates several features (link, rotatable lug, lever and associated pivots), all of which are costly.

U.S. Pat. No. 5,564,761 shows a closure link that is disengageable from the rotating claw. A serpentine guide track ensures the link correctly engages the claw. The forces required to close the latch can be relatively high, and thus the serpentine guide track must be strong enough to correctly guide the link.

U.S. Pat. No. 5,288,115 shows a similar closing link also guided by a serpentine guide track. The serpentine guide tracks of U.S. Pat. No. 5,564,761 and U.S. Pat. No. 5,288,115 are complicated and expensive to produce, not least because they must be sufficiently strong to withstand the various closure loads applied to them.

Further examples of latches are shown in U.S. Pat. No. 6,382,687, EP0879926, US2003/0080569 and US2003/0062727.

### SUMMARY OF THE INVENTION

The present invention provides a simpler closure mechanism that is easier and cheaper to produce and quicker to assemble.

Thus, the present invention provides a latch assembly including a chassis and a latch bolt having a power closure abutment, a first safety abutment and a closed abutment. The latch bolt is rotatably mounted on the chassis and moveable between an open position, a first safety position and a closed position. The latch assembly includes a pawl including a pawl tooth mounted on the chassis. The pawl has an engaged position defined by engagement between the pawl tooth and one of the first safety abutment and the closed abutment at which the pawl releaseably retains the latch bolt in one of the first safety position and the closed position, respectively, and a released position in which the latch bolt is free to move to the open position.

The latch assembly also includes a closure element having a first abutment and a second abutment, a closure transmission path and a power actuator. The first abutment is releaseably engageable with the closure abutment, and the transmission path is connected to the closure element at the second abutment to operably connect the power actuator to the closure element. The closure element has a first position at which the closure element is disengaged from the closure abutment, a second position at which the first abutment of the closure element is engaged with the closure abutment and the latch bolt is in the first safety position, and a third position at which the first abutment of the closure element is engaged with the closure abutment and the latch bolt is in the closed position.

When the closure element is in the first position and the latch bolt is in the first safety position, actuation of the power actuator causes the closure element to move through the second position to the third position, thereby closing the latch. During movement of the closure elements from the second position into the third position, the closure abutment is positioned generally between the first abutment and the second abutment.

### BRIEF DESCRIPTION OF THE DRAWINGS

The invention will now be described, by way of example only, with a reference to the accompanying drawings in which,

FIG. 1 is a view of a latch assembly according to the present invention in an open position;

FIG. 1A is a view of a closure element mounting a spring, a bowden cable inner and a closure element;

FIG. 2 is a view of the latch assembly in a first safety position;

FIG. 3 is a view of the latch assembly in another position with the claw in a fully closed position;

FIG. 4 is a view of the latch assembly in a fully closed position;

FIG. 5 is an asymmetric view of FIG. 2; and

FIG. 6 is part of a view of a second embodiment of the latch assembly according to the present invention.

### DETAILED DESCRIPTION OF THE PREFERRED EMBODIMENT

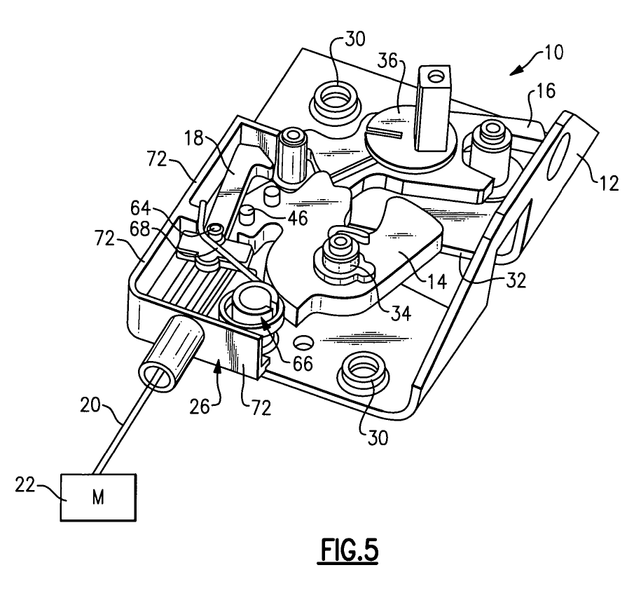

As shown in FIG. 5, a latch assembly 10 includes a latch chassis 12, a latch bolt in the form of a rotating claw 14, a pawl 16, a closure element 18, a transmission path 20 and an actuator 22.

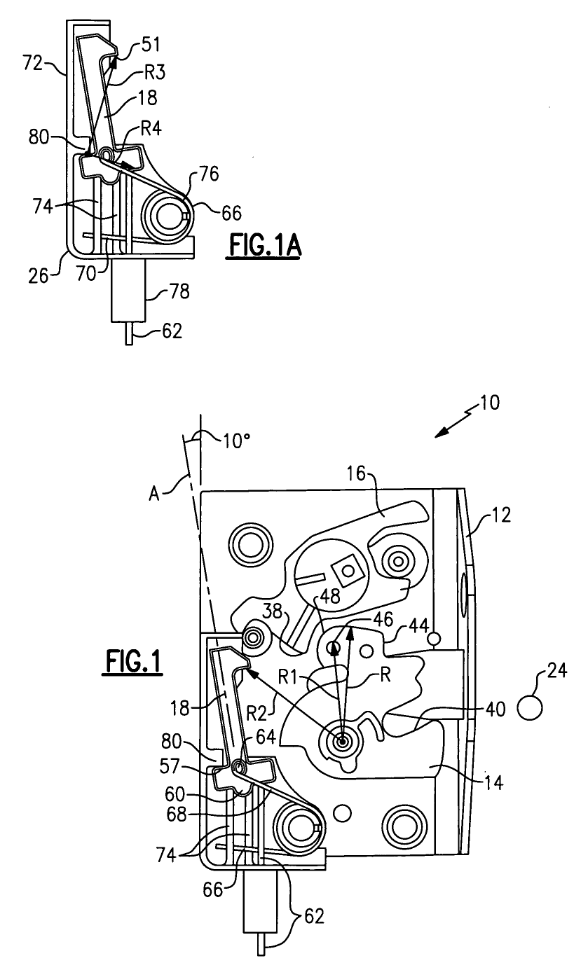

The chassis 12 is a retention plate made of metal, such as steel, for example. Holes 30 enable the fully assembled latch assembly 10 to be secured to an associated door. The chassis 12 includes a mouth 32 for receiving a striker 24 (shown in FIG. 1). The claw 14 rotates about a claw pivot 34 mounted on the chassis 12, and the pawl 16 rotates about a pawl pivot 36 mounted on the chassis 12.

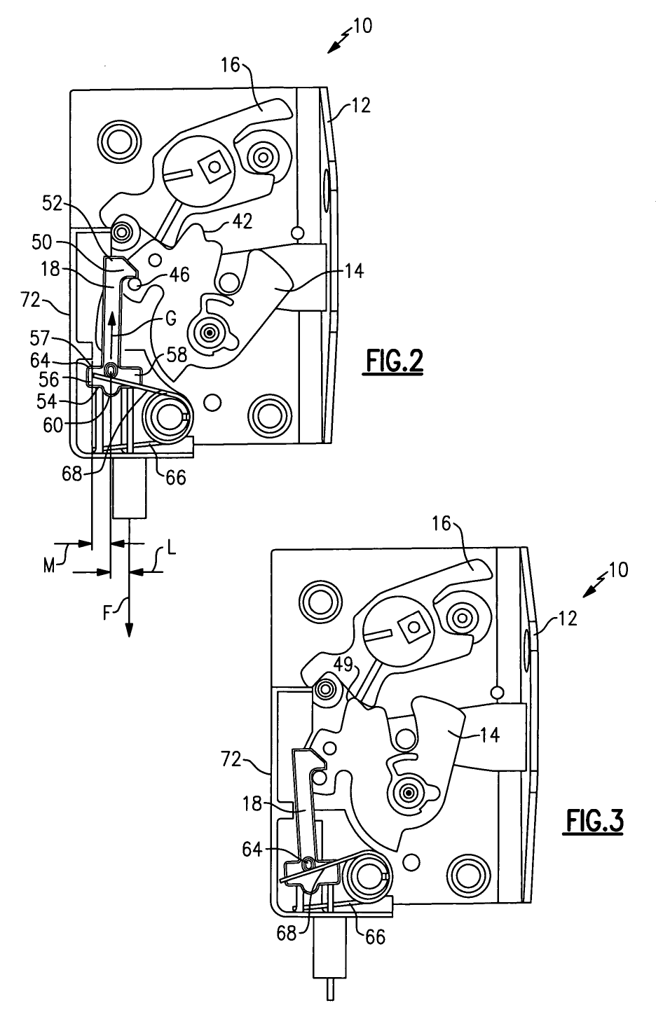

As shown in FIG. 1, the pawl 16 includes a pawl tooth 38. The claw 14 includes a claw mouth 40 for receiving the striker 24, a closed abutment 42 (shown in FIG. 2) and a first safety abutment 44. The rotating claw 14 also includes a power closure abutment in the form of an upstanding pin 46.

As shown in FIG. 2, the closure element 18 is generally elongate and includes a first end 52 having a hook 50 and a second end 54 including a first laterally projecting boss 56, a second laterally projecting boss 58 and a third downwardly projecting boss 60. The first boss 56 includes a stop surface 57. The second boss 58 includes a recess (not shown), and a cable nipple (not shown) fixed to an end of a bowden cable inner 62 (shown in FIG. 1) is secured into the recess in a manner known to those skilled in the art. The third boss 60 includes a pin (not shown) that projects into the plane of the paper when viewing FIG. 1 and is obscured by the third boss 60.

As shown in FIG. 5, a pin 64 projects from the general plane of the closure element 18 and acts as an abutment for a first arm 68 of a spring 66. A second arm of the spring 66 abuts against a portion of a closure element mounting 26.

FIG. 1A shows just the closure element mounting 26, the spring 66, the bowden cable inner 62 and the closure element 18. FIG. 1A and FIG. 5 show that the closure element mounting 26 includes walls 72 which partially form a housing of the closure element 18. The closure element mounting 26 includes guide rails 74 which guide the pin of the third boss 60, as will be further described below. A boss 76 acts as a mount for the helical portion of the spring 66. A cylindrical boss 78 receives a bowden cable outer (not shown). The closure element mounting 26 further includes a stop feature 80.

When viewing FIG. 1, the pawl 16 is biased in a counter-clockwise direction via a spring (not shown), and the rotating claw 14 is biased in a clockwise direction via a spring (not shown).

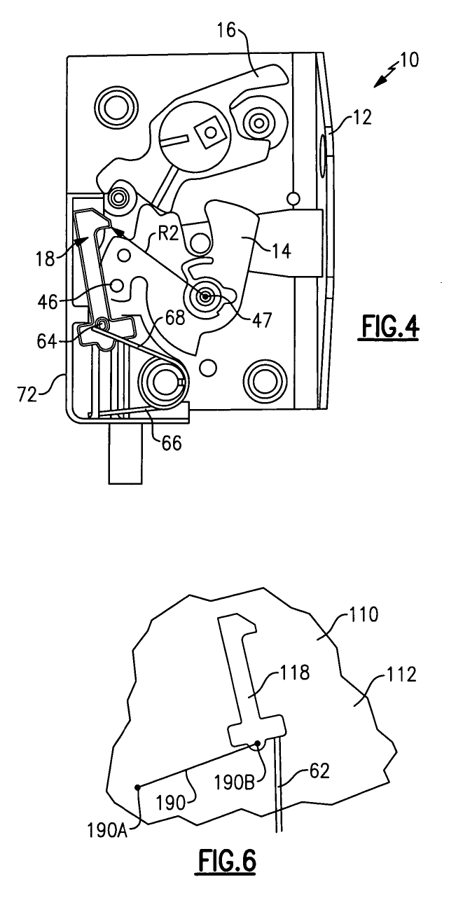

As shown in FIG. 5, the first arm 68 acts upon the pin 64 to bias the closure element 18 generally upwardly in a direction G (shown in FIG. 2). Because the pin (not shown) of the third boss 60 sits within guide rails 74, the stop surface 57 of the closure element 18 is biased against the stop feature 80 and the stop feature 80 and the stop surface 57 are offset laterally relative to the pin 64, the closure element 18 adopts the position shown in FIG. 1 in which a longitudinal axis A of the closure element 18 is offset counter-clockwise from the vertical position, in this case by 10°. This results in a tip 51 (shown in FIG. 1A) of the hook 50 being positioned at a radius R2 from a claw pivot axis 47 (shown in FIG. 4). The radius R2 is greater than a radius R1, which is defined as the radial distance from the claw pivot axis 47 to an outer edge of the upstanding pin 46.

FIGS. 1 to 4 show the sequence of events that occurs during closing of the latch. In summary, starting with an open latch as shown in FIG. 1, the door is initially manually moved to a first safety position. A motor M is then actuated, which causes the bowden cable inner 62 to move the hook 50 into engagement with the upstanding pin 46, as shown in FIG. 2. Continued actuation causes the closure element 18 to move generally linearly downwardly, thus pulling the rotating claw 14 to the fully closed position, as shown in FIG. 3. Power to the motor M is then cut, and the closure element 18 is returned to the start position under the action of the spring 66 (see FIG. 4).

In more detail, when the door is manually closed, the pin 46 moves past the tip 51 without touching it, because the pin 46 is positioned closer to the claw pivot axis 47 (i.e., at radius R1) than the distance between the tip 51 and the claw pivot axis 47 (i.e., radius R2).

The claw 14 includes a ramp surface 48 which, when the claw 14 is moved from the FIG. 1 position to the FIG. 2 position, engages the pawl tooth 38, thereby causing the pawl 16 to rotate clockwise slightly until the ramp surface 48 has passed under the pawl tooth 38, whereupon the pawl 16 rotates counter-clockwise under the action of the spring (not shown) to the FIG. 2 position. In this position, the pawl tooth 38 is engaged behind the first safety abutment 44, and as such the door will not open but is nevertheless not fully closed.

Once the claw 14 and the pawl 16 have achieved the FIG. 2 position, a sensor (not shown) senses this condition and instructs actuation of the actuator 22. This causes the bowden cable inner 62 to move generally downwardly. A line of force F of the bowden cable is applied to the second boss 58 and is resisted by a force G of the first arm 68 acting on the pin 64. Because the pin 64 is laterally offset from the second boss 58 by a distance L, a couple is produced as the bowden cable force F overcomes the spring force G, which causes the closure element 18 to generally rotate clockwise, thereby engaging the hook 50 with the upstanding pin 46 of the rotating pawl 16. Continued downward movement of the bowden cable inner 62 causes the stop surface 57 to move away from the stop feature 80, as shown in FIG. 2.

Thus, the FIG. 2 position shows the latch in the first safety position but with the hook 50 engaging the pin 46 and the power actuator 22 on the point of starting to move the latch towards the fully closed position. Thus, continued downward movement of the bowden cable inner 62 pulls the closure element 18 downwardly when viewing FIG. 2, which in turn causes the closure element 18 to rotate the claw 14 to the fully closed position, shown in FIG. 3.

Thus, in FIG. 3, the pawl tooth 38 has just ridden over the ramp surface 48 of the rotating claw 14 and has engaged the closed abutment 42. Upon reaching the FIG. 3 position, power to the motor M is cut, and the spring 66 then moves the closure element 18 generally vertically upwardly when viewing FIG. 3. However, when the stop surface 57 engages the stop feature 80, the closure element 18 will then rotate slightly counter-clockwise about the contact point between the stop surface 57 and the stop feature 80 because the contact point is laterally offset by a distance D relative to the pin 64 of the closure element 18 where the spring force G is applied to the closure element 18. Thus, FIG. 4 shows the latch in the fully closed position, and the closure element 18 is in the same position in FIG. 4 as it is in FIG. 1. Thus, the hook tip 51 is again positioned at the radius R2, as shown in FIG. 4. On subsequent release of the latch, the upstanding pin 46, which is positioned at the radius R1 from the claw pivot axis 47, is able to pass the tip 51, thereby allowing full opening of the latch.

The latch is released by the pawl 16 being rotated clockwise such that the pawl tooth 38 disengages from the first safety abutment 44, in a manner well known in the art, thereby allowing the latch to move to the FIG. 1 position and release the striker 24.

Consideration of FIG. 2 shows that the upstanding pin 46 is positioned generally between the hook 50 and the second boss 58 where the tensile force of the bowden cable is applied during closing. Thus, the closure element 18 “pulls” the claw 14 to the closed position. This can be contrasted with the prior art patents U.S. Pat. No. 5,288,115 and U.S. Pat. No. 5,564,761, where the claw is “pushed” to the closed position by the appropriate link. Thus, in U.S. Pat. No. 5,288,115 and U.S. Pat. No. 564,761, the serpentine guide track must be strong enough to properly guide the link. The arrangement of the present invention does not require guiding of the closure element 18 during closure of the latch, because by “pulling” the closure element 18, it automatically self aligns. The primary purpose of the guide rails 74 is to ensure that the closure element 18 is guided correctly back to the position shown in FIG. 1 from the position shown in FIG. 4. During the guiding process, the forces involved are considerably lower than the forces involved when closing the latch, and hence the guide rail 74 can be relatively light weight and relatively weak.

Thus, one part of the closure element 18 (the hook 50) is positioned on one side of the closure abutment 46 of the claw 14, and another part of the closure element 18 (the second boss 58) is positioned on the other side of the closure abutment 46 of the claw 14 to allow the claw 14 to be pulled shut. Consideration of U.S. Pat. No. 5,564,761 and U.S. Pat. No. 5,288,115 show that that part of the link that engages the claw and the part of the link that is driven by the closure mechanism both lie on the same side of the claw abutment to enable the links to push the claw closed.

By pulling the claw 14 closed, the requirement to guide the closure element 18 is significantly reduced, thereby reducing costs when manufacturing a latch according to the present invention.

The latch assembly 10 includes the pawl 16 having a single pawl tooth 38 that engages two abutments of the claw 14, i.e., the pawl tooth 38 either engages the closed abutment 42 or the first safety abutment 44. In further embodiments, the pawl 16 could be provided with two pawl teeth which engage a single abutment on the claw 14 to provide the first safety position and the closed position, and the features described herein in relation to the latch assembly 10 are equally applicable to this further embodiment.

The actuator 22 does relatively little work when moving the closure element 18 from the FIG. 1 position to the FIG. 2 position. In fact, the only work done is to overcome the preloading spring 66, then to slightly tension the spring 66 further and to overcome any frictional loads. The spring 66 is relatively light and hence frictional loads will also be relatively low.

However, the actuator 22 has to provide considerably more work when moving from the FIG. 2 position to the FIG. 3 position. During this period of operation, the door itself is being fully closed and therefore compresses the weather seal which sits around the periphery of the door and seals against the body of the vehicle.

By way of example, typically a load of 10 newtons is required in the bowden cable inner 62 to move the closure element 18 from the FIG. 1 position to the FIG. 2 position. However, typically a load of 600 newtons is required in the bowden cable inner 62 to move the closure element 18 and rotate that claw 14 and associated door from the FIG. 2 position to the FIG. 3 position. Thus, the actuator 22 is working well within its capabilities when moving the power closure element from the FIG. 1 position to the FIG. 2 position. The applicant has designed a system which therefore allows the tip 51 of the hook 50 to quickly engage the pin 46, while minimizing the stroke requirement of the actuator 22 during this period. Thus, FIG. 1A shows that the tip 51 is spaced at a radius R3 from the pivot point of the closure element 18 during initial operation. However, the bowden cable inner 62 is spaced at a radius R4 from the pivot point. The radius R3 is approximately twice the radius R4. Thus, during the pivoting of the closure element 18, the tip 51 travels approximately 2 millimeters for every one millimeter of travel of the bowden cable inner 62. However, when moving from the FIG. 2 position to the FIG. 3 position, the tip 51 also moves approximately 1 millimeter for every 1 millimeter of travel of the bowden cable inner 62. The applicant has therefore provided a simple system whereby the ratio of movement of the tip 51 to movement of the bowden cable inner 62 varies during closure, and this minimizes the stroke of the actuator 22 during a period of operation (movement from the FIG. 1 position to the FIG. 2 position) when minimum force is required.

As mentioned above, the radius R3 is approximately twice the radius R4. In further embodiments, the same effect can be achieved provided the radius R3 is greater than the radius R4. However, preferably the radius R3 is 1.5 (or more) times the radius R4 and more preferably the radius R3 is 2 (or more) times the radius R4.

As previously mentioned, once the latch has been fully closed, the spring 66 returns the closure element 18 to the FIG. 5 position from the FIG. 3 position. This return movement is continuous, but is in two parts. Thus, the spring 66 initially moves the closure element 18 generally upwardly (generally linearly) from the FIG. 3 position to the FIG. 2 position (albeit with the rotating claw 14 in the closed position). Then, the spring 66 causes the closure element 18 to rotate counter-clockwise about the contact point between the stop surface 57 and the stop feature 80. Thus, when the closure element 18 is in the first position (the FIG. 1 position), the spring 66 biases the closure element 18 towards this first position, i.e., away from the second position (as shown in FIG. 2).

The spring 66 has a helical portion and two tangentially extending arms (the first arm 68 and the second arm 70, which reacts against a part of the latch chassis). In further embodiments, alternative resilient members could be used, such as a helical compression spring, a helical tension spring, a leaf spring, a spiral spring, and a resilient block (such as a block of rubber). Where a resilient block is used, it could be used in tension or compression or in bending (in a manner similar to a tension spring or a compression spring or a leaf spring).

FIG. 6 shows a further embodiment of a latch assembly 110. The latch assembly 110 differs from the latch assembly 10 only in the manner in which a closure element 118 is guided. Therefore, FIG. 6 only shows the guiding feature, and the other features of the latch assembly 110 that are not shown are the same as those of the latch assembly 10.

In this case, the closure element 118 is guided by a link 190 (shown schematically) which is pivotally mounted at one end 190A to a latch chassis 112 and pivotally mounted at another end 190 to the closure element 118. The bowden cable inner 62 is generally tangentially orientated relative to the arc about which the end 190B moves during operation of the latch. This minimizes the forces on the pivot at the end 190A. The spring 66 (not shown in FIG. 6) acts on the closure element 118 in a manner similar to the action of the spring 66 on the closure element 18.

The alternative resilient members described above in relation to the closure element 18 are equally applicable to the closure element 118.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A latch assembly comprising:
a chassis;
a latch bolt including a power closure abutment, a first safety abutment and a closed abutment, wherein the latch bolt is rotatably mounted on the chassis and moveable between an open position, a first safety position and a closed position;
a pawl including a pawl tooth, wherein the pawl is mounted on the chassis and has an engaged position defined by engagement between the pawl tooth and one of the first safety abutment and the closed abutment at which the pawl releaseably retains the latch bolt in one of the first safety position and the closed position respectively, and a released position in which the latch bolt is free to move to the open position;
a closure element including a first abutment and a second abutments;
a closure transmission paths; and
a power actuator;
wherein the first abutment is releaseably engageable with the power closure abutment and the closure transmission path is connected to the closure element at the second abutment to operably connect the power actuator to the closure element,
wherein the closure element has a first position at which the closure element is disengaged from the power closure abutment, a second position at which the first abutment of the closure element is engaged with the power closure abutment and the latch bolt is in the first safety position, and a third position at which the first abutment of the closure element is engaged with the power closure abutment and the latch bolt is in the closed position, and
wherein with the closure element in the first position and the latch bolt in the first safety position, actuation of the power actuator causes the closure element to move through the second position to the third position to close the latch assembly, and during movement of the closure element from the second position into the third position, the power closure abutment of the latch bolt is positioned generally between the first abutment and the second abutment of the closure element, and with the closure element in the first position, a resilient member biases the closure element away from the second position.

2. The latch assembly as defined in claim 1 wherein a line defined between the first abutment and the second abutment defines a direction and the closure transmission path applies a closing force to the closure element that is generally in the direction and away from the first abutment.

3. The latch assembly as defined in claim 1 wherein the closure element pivots about a generally fixed axis when moving between the first position and the second position.

4. The latch assembly as defined in claim 3 wherein a line defined between the first abutment and the second abutment defines a direction, and the closure transmission path applies a closing force to the closure element generally in the direction and away from the first abutment, and the generally fixed axis is offset laterally relative to the second abutment with respect to the direction.

5. The latch assembly as defined in claim 1 wherein the resilient member returns the closure element from the third position to the first position following closing of the latch assembly.

6. The latch assembly as defined in claim 3 wherein the closure element includes a spring abutment, and the resilient member applies a load to the spring abutment in a direction and the generally fixed axis is offset laterally relative to the spring abutment with respect to the direction.

7. The latch assembly as defined in claim 1 wherein the closure element moves generally linearly between the second position and the third position.

8. The latch assembly as defined in claim 1 wherein a portion of the closure element that is adjacent to the second abutment is at least partially guided.

9. The latch assembly as defined in claim 1 wherein the closure transmission path includes a bowden cable having a bowden cable inner that is connected to the second abutment.

10. The latch assembly as defined in claim 9 wherein the bowden cable includes a bowden cable outer having an end fitting with one of a guide, a spring location feature and a housing wall.

11. The latch assembly as defined in claim 1 wherein the first abutment travels a first distance and the second abutment travels a second distance when the closure element moves from the first position to the second position, and the first distance is at least approximately 1.5 times the second distance.

12. The latch assembly as defined in claim 11 wherein the closure element pivots about a generally fixed axis when moving between the first position and the second position and the first abutment is positioned at a first radius from the generally fixed axis and the second abutment is positioned at a second radius from the generally fixed axis, and the first radius is at least approximately 1.5 times the second radius.

13. A latch assembly comprising:
a chassis;
a latch bolt including a power closure abutment and a tooth, wherein the latch bolt is rotatably mounted on the chassis and moveable between an open position, a first safety position and a closed position;
a pawl including a first safety abutment and a closed abutment, wherein the pawl is mounted on the chassis and has an engaged position defined by engagement between the tooth of the latch bolt and one of the first safety abutment and the closed abutment of the pawl at which the pawl releaseably retains the latch bolt in one of the first safety position and the closed position, respectively, and a released position in which the latch bolt is free to move to the open position;
a closure element including a first abutment and a second abutment;
a closure transmission path; and
a power actuator,
wherein the first abutment is releaseably engageable with the power closure abutment and the closure transmission path is connected to the closure element at the second abutment to operably connect the power actuator to the closure element,
wherein the closure element has a first position at which the closure element is disengaged from the power closure abutment, a second position at which the first abutment of the closure element is engaged with the closure abutment and the latch bolt is in the first safety position, and a third position at which the first abutment of the closure element is engaged with the power closure abutment and the latch bolt is in the closed position, and
wherein with the closure element in the first position and the latch bolt in the first safety position, actuation of the power actuator causes the closure element to move through the second position to the third position, to close the latch assembly, and during movement of the closure element from the second position into the third position, the power closure abutment of the latch bolt is positioned generally between the first abutment and the second abutment, and with the closure element in the first position, a resilient member biases the closure element away from the second position.
